(19) United States
(12) Patent Application Publication
(10) Pub. No.: US 2016/0023686 A1
(43) Pub. Date: Jan. 28, 2016

(54) VEHICLE CEILING AND VEHICLE USING SAME

(71) Applicant: TOYOTA JIDOSHA KABUSHIKI KAISHA, Toyota-shi (JP)

(72) Inventors: Hideyuki SAKURAI, Toyota-shi (JP); Akihiro TAMAOKI, Tajimi-shi (JP)

(21) Appl. No.: 14/808,830

(22) Filed: Jul. 24, 2015

(30) Foreign Application Priority Data
Jul. 28, 2014 (JP) 2014-153345

(51) Int. Cl. B62D 25/06; B62D 31/00

(52) U.S. Cl. CPC B62D 25/06; B62D 31/00

(57) ABSTRACT

A vehicle ceiling includes: a ceiling main body that is formed in a generally rectangular flat sheet shape, one surface of the ceiling main body being a ceiling surface; and a linear design portion that extends in a straight line or a curved line in a length direction of the ceiling main body such that at least a portion that is positioned on a ceiling front side is not parallel to a first center line, and that forms an accent that is visibly recognizable by a rear occupant when the vehicle ceiling is mounted to a vehicle. The first center line extends in the length direction and passes through a width direction middle position of the ceiling surface.

### INCORPORATION BY REFERENCE

The disclosure of Japanese Patent Application No. 2014-153345 filed on Jul. 28, 2014 including the specification, drawings and abstract is incorporated herein by reference in its entirety.

### BACKGROUND OF THE INVENTION

1. Field of the Invention

The invention relates to a vehicle ceiling and a vehicle using this vehicle ceiling.

2. Description of Related Art

In a vehicle, particularly a compact vehicle, there is a need to devise a way to make an occupant feel as though a cabin interior is spacious.

However, in addition to long objects such as curtain airbag devices and wire harnesses being provided on both sides on the reverse side of a roof headlining, mounting brackets for assist grips and the like are also arranged on the reverse side of the roof headlining. Therefore, it is not easy to expand the ceiling surface toward the vehicle cabin outside.

In the technology described in Japanese Patent Application Publication No. 2013-067225 (JP 2013-067225 A), in order to make the cabin interior feel not so closed in, the ceiling surface of the roof headlining is divided into different colors based on brightness, such that shadows from sunlight will not easily stand out, thereby giving an occupant a less closed-in feeling. Although this kind of technology also helps to improve interior comfort, it does not give the occupant the feeling that the cabin interior is spacious. In addition, there are also issues such as the glare of the road while driving, and light and dark on the ceiling caused by changes in the surrounding environment are unable to be controlled.

### SUMMARY OF THE INVENTION

The invention thus provides a vehicle ceiling that is able to make an occupant in a rear seat feel that a cabin interior is spacious, as well as a vehicle that uses this vehicle ceiling.

A first aspect of the invention relates to a vehicle ceiling that includes a ceiling main body that is formed in a generally rectangular flat sheet shape, one surface of which is a ceiling surface; and a linear design portion that extends in a straight line or a curved line in a length direction of the ceiling main body such that at least a portion that is positioned on a ceiling front side is not parallel to a first center line that extends in the length direction and passes through a width direction middle position of the ceiling surface, and that forms an accent that is visibly recognizable by a rear occupant when the vehicle ceiling is mounted to a vehicle.

According to this aspect, the ceiling main body is formed in a generally rectangular flat sheet shape and one surface of the ceiling main body is a ceiling surface. Here, in this aspect of the invention, a linear design portion is provided on the ceiling surface. This linear design portion extends in a straight line or a curved shape in the length direction of the ceiling main body, and at least a portion that is positioned on the ceiling front side is not parallel to the first center line that extends in the length direction and passes through the width direction middle position of the ceiling surface. Therefore, when an occupant is seated facing forward in a rear seat while the vehicle ceiling is mounted to a vehicle, an accent line formed by the linear design portion is in the field of view of the rear occupant, and a visual effect (a sense of perspective depth and a feeling of spaciousness in the vehicle width direction of the seating space) caused by the difference in distance (i.e., wide and narrow) between the accent line and the end of the long side of the ceiling main body 16 is obtained.

The vehicle ceiling according to the first aspect of the invention has a beneficial effect in which the rear occupant can be made to feel that the inside of the cabin is spacious.

In the aspect described above, the linear design portion may extend beyond a front seat from a front end portion of the ceiling main body, when the vehicle ceiling is mounted to a vehicle.

According to this structure, the linear design portion extends beyond the front seat from the front end portion of the ceiling main body, when the vehicle ceiling is a state mounted to the vehicle, so an accent line formed by the linear design portion is accentuated for the rear occupant.

The vehicle ceiling according to this structure of the invention has a beneficial effect in which a visual effect for the rear occupant is able to be increased.

In the aspect or structure described above, a plurality of the linear design portion may be arranged bilaterally symmetrical with respect to the first center line.

According to this structure, the linear design portion is arranged bilaterally symmetrical with respect to the first center line, so the visual effect described above is able to be obtained regardless of whether the occupant is seated on the right side or the left side in the rear seat. Also, when occupants are seated on both the left and right sides in the rear seat, the visual effect described above is able to be obtained for each occupant.

The vehicle ceiling according to the structure described above has a beneficial effect in which rear occupants are made to feel that the inside of the cabin is spacious, regardless of the seating position of the rear occupants, and whether the number of rear occupants is one or two.

In the aspect or structures described above, the linear design portion may be provided on the ceiling main body in a manner such that a distance between the linear design portion and a long side edge of the ceiling main body is wider on a ceiling main body rear side than on a ceiling main body front side.

According to this structure, the linear design portion is provided on the ceiling main body in a manner such that a distance between the linear design portion and a long side edge of the ceiling main body is wider on a ceiling main body rear side than on a ceiling main body front side. That is, the distance between the linear design portion and the end of the long side of the ceiling main body becomes wider toward the rear occupant. Therefore, when this vehicle ceiling is mounted to the vehicle, the rear occupant feels that the space above his or her head is actually wider than it really is in the width direction of the ceiling main body.

The vehicle ceiling according to this structure has a beneficial effect in which it is able to make the rear occupant feel that the cabin interior is spacious in the vehicle width direction, by giving the impression that the space above the head of the rear occupant is actually wider than it really is in the width direction of the ceiling main body.

In the aspect or structures described above, the linear design portion may be provided on the ceiling main body in a manner such that a distance between the linear design portion and a long side edge of the ceiling main body is narrower on a ceiling main body rear side than on a ceiling main body front side.

According to this structure, the linear design portion is provided on the ceiling main body in a manner such that a distance between the linear design portion and a long side edge of the ceiling main body is narrower on a ceiling main body rear side than on a ceiling main body front side. That is, the distance between the linear design portion and the end of the long side of the ceiling main body decreases toward the rear occupant. Therefore, when this vehicle ceiling is mounted to the vehicle, the vehicle front side appears farther away that it really is to the rear occupant.

The vehicle ceiling according to this structure has a beneficial effect in which it is able to make the rear occupant feel that the cabin interior is spacious in the vehicle front-rear direction, by giving the rear occupant the impression that the vehicle front side is actually farther away than it really is.

In the aspect or structures described above, a plurality of the linear design portions may be provided apart from each other in a width direction of the ceiling main body between the first center line and a long side edge of the ceiling main body, and may be provided on the ceiling main body in a manner such that a distance between the plurality of linear design portions is wider on a ceiling main body rear side than on a ceiling main body front side.

According to this structure, a plurality of the linear design portions are provided apart from each other in a width direction of the ceiling main body between the first center line and a long side edge of the ceiling main body, and are provided on the ceiling main body in a manner such that a distance between the plurality of linear design portions is wider on a ceiling main body rear side than on a ceiling main body front side. Therefore, when this vehicle ceiling is mounted to the vehicle, the rear occupant feels as though the space over his or her head is even wider than it really is in the width direction of the ceiling main body.

The vehicle ceiling according to this structure has a beneficial effect in which it is able to make the rear occupant feel that the cabin interior is even more spacious in the vehicle width direction, by giving the impression that the space above the head of the rear occupant is actually wider than it really is in the width direction of the ceiling main body.

In the aspect or structures described above, a plurality of the linear design portions may be provided apart from each other in a width direction of the ceiling main body between the first center line and a long side edge of the ceiling main body, and may be provided on the ceiling main body in a manner such that a distance between the plurality of linear design portions is narrower on a ceiling main body rear side than on a ceiling main body front side.

According to this structure, a plurality of the linear design portions are provided apart from each other in a width direction of the ceiling main body between the first center line and a long side edge of the ceiling main body, and are provided on the ceiling main body in a manner such that a distance between the plurality of linear design portions is narrower on a ceiling main body rear side than on a ceiling main body front side. Therefore, when this vehicle ceiling is mounted to the vehicle, the vehicle front side appears to be even farther away than it really is to the rear occupant.

The vehicle ceiling according to this structure has a beneficial effect in which it is able to make the rear occupant feel that the cabin interior is even more spacious in the vehicle front-rear direction, by giving the rear occupant the impression that the vehicle front side is actually farther away than it really is.

In the structures described above, the plurality of linear design portions may extend separated on both left and right sides of a second center line that extends in a length direction of the ceiling surface, parallel to the first center line.

According to this structures, the plurality of linear design portions extend separated on both left and right sides of a second center line that extends in a length direction of the ceiling surface, parallel to the first center line, so the accent line of the linear design portion is able to be effectively recognized by both eyes of the rear occupant. Therefore, the rear occupant is able to be provided with a strong visual effect.

The vehicle ceiling according to this structure has a beneficial effect in which it is able to effectively make the rear occupant feel that the cabin interior is spacious.

In the structure described above, the second center line may pass through the center of an occupant seating position in a rear seat.

According to this structure, the second center line passes through the center of an occupant seating position in a rear seat, so the accent line of the linear design portion is able to be most effectively recognized by both eyes of the rear occupant. Therefore, the rear occupant is able to be provided with the strongest visual effect.

The vehicle ceiling according to this structure has a beneficial effect in which it is able to most effectively make the rear occupant feel that the cabin interior is spacious.

In the aspect or structures described above, the linear design portion may be formed by a shape of the ceiling main body itself.

According to this structure, the linear design portion is formed by a shape of the ceiling main body itself, so compared to a structure in which the accent line is formed by another part that is attached to the ceiling main body, not only is the number of parts able to be reduced, but an extremely natural accent line is able to be created.

The vehicle ceiling according to this structure has a beneficial effect in which it is able to give the rear occupant the feeling that the inside of the cabin is naturally spacious.

A second aspect of the invention relates to a vehicle that includes a cabin that forms a space where an occupant rides; and the vehicle ceiling according to the first aspect that lines an upper portion of the cabin, such that the ceiling surface on which the linear design portion is provided faces an inside of the cabin.

According to this aspect, the vehicle ceiling according to the first aspect lines an upper portion of the cabin, such that the ceiling surface on which the linear design portion is provided faces the inside of the cabin, so the visual effect realized by the invention according to the aspects and various structures thereof is able to be achieved.

The vehicle ceiling according to the aspect and structures described above has a beneficial effect in which it is able to give an occupant seated in a rear seat the feeling that the inside of the cabin is spacious.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an external view of a cabin interior that shows a cabin interior roof side of a vehicle provided with a vehicle ceiling according to a first example embodiment of the invention, as viewed from the center of a rear seat;

FIG. 2 is a plan view of the vehicle ceiling shown in FIG. 1, as viewed from a design surface side;

FIG. 3 is an enlarged sectional view of a groove, taken along line III-III in FIG. 2;

FIG. 4 is a front view corresponding to FIG. 2, of attachment points where the vehicle ceiling shown in FIG. 2 is attached to a vehicle body upper portion;

FIG. 5 is a perspective view, as viewed from the rear seat side, of the cabin interior of a vehicle provided with the vehicle ceiling shown in FIG. 2;

FIG. 6 is a plan view of the right half of the vehicle shown in FIG. 5;

FIG. 7 is an enlarged sectional view centered on a roof side rail, taken along line VII-VII in FIG. 6;

FIG. 8 is a plan view corresponding to FIG. 2, of a roof headlining according to a first modified example of the first example embodiment of the invention;

FIG. 9 is a plan view corresponding to FIG. 2 of a roof headlining according to a second modified example of the first example embodiment of the invention;

FIG. 10 is a plan view corresponding to FIG. 2 of a roof headlining according to a third modified example of the first example embodiment of the invention;

FIG. 11 is a plan view corresponding to FIG. 2 of a roof headlining according to a fourth modified example of the first example embodiment of the invention;

FIG. 12 is an external view of a cabin interior corresponding to FIG. 1, that shows a cabin interior roof side of a vehicle provided with the vehicle ceiling shown in FIG. 11, as viewed from the center of the rear seat;

FIG. 13 is a plan view corresponding to FIG. 2 of a roof headlining according to a fifth modified example of the first example embodiment of the invention;

FIG. 14 is a plan view of a first example of a vehicle ceiling according to a second example embodiment of the invention, as viewed from a design surface side;

FIG. 15 is a plan view corresponding to FIG. 14, of a second example of the vehicle ceiling according to the second example embodiment of the invention; and

FIGS. 16A, 16BA, 16BB, 16BC, 16C, 16D and 16E are enlarged sectional views corresponding to FIG. 3, of modified examples of the structure of the linear design portion.

### DETAILED DESCRIPTION OF EMBODIMENTS

### First Example Embodiment

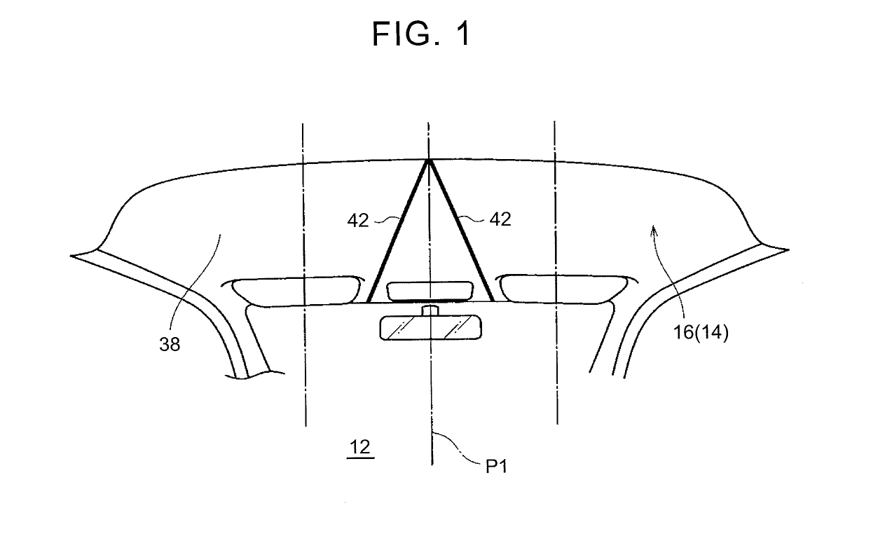

Hereinafter, a first example embodiment of a vehicle ceiling and a vehicle using this vehicle ceiling according to the invention will be described with reference to FIGS. 1 to 7. In the drawings, arrow FR indicates a vehicle front side, and arrow UP indicates a vehicle upward side. Furthermore, arrow IN indicates a vehicle width direction inside.

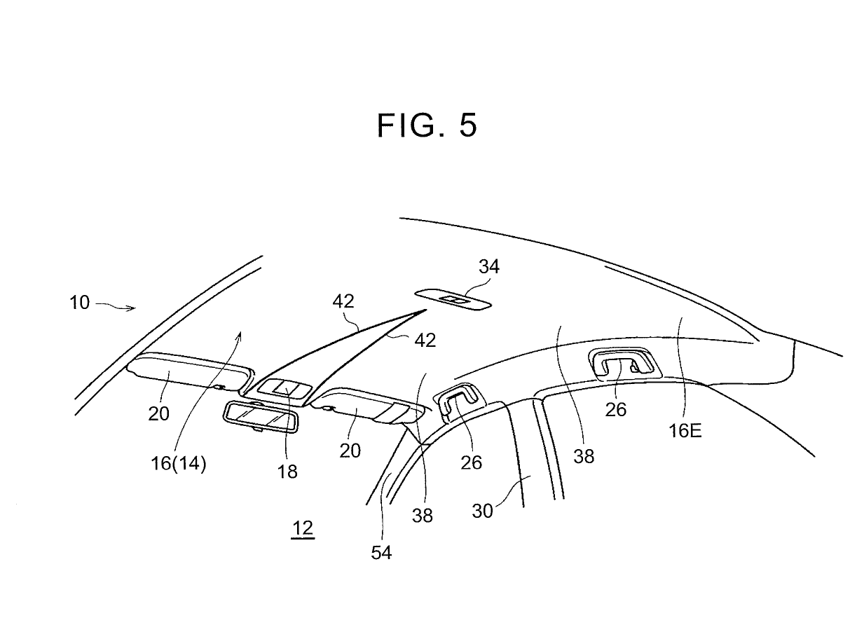

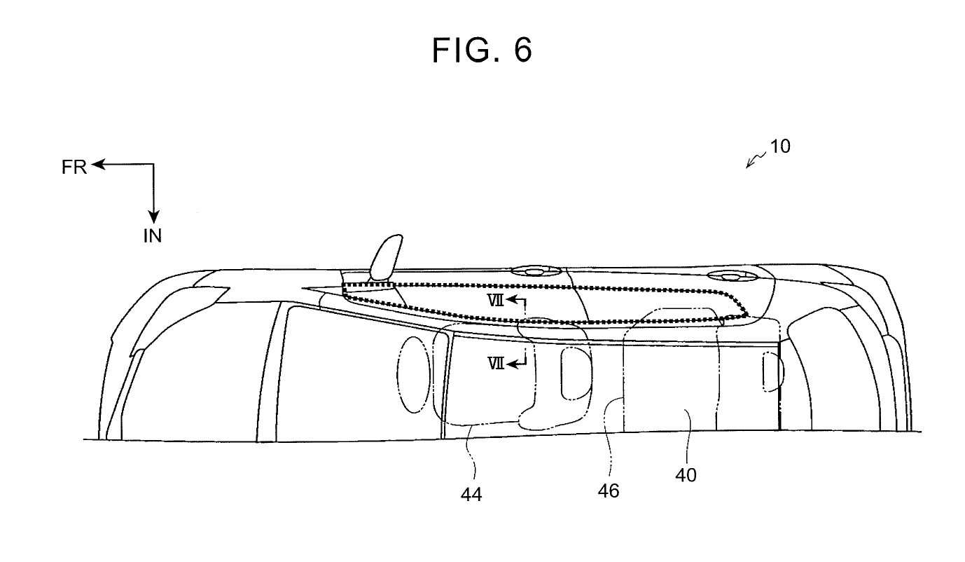

FIG. 6 is a plan view of the right half of the outside of an automobile according to this example embodiment. Also, FIG. 5 is an outline view, as viewed from the rear seat side, of the cabin interior of the automobile. As shown in these drawings, an automobile 10 that serves as the vehicle includes a cabin 12 that is a space inside the vehicle where an occupant rides. A roof headlining (molded ceiling) 14 that serves as the vehicle ceiling lines an upper portion of the cabin 12.

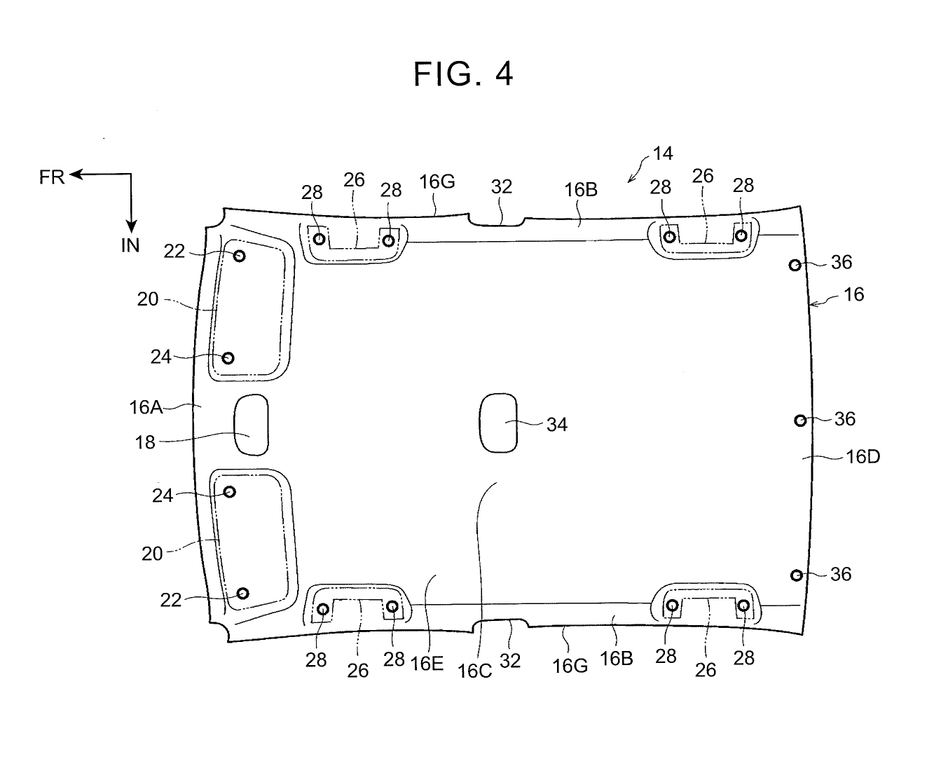

FIG. 4 is a view of one example of a method of fixing the roof headlining 14 to a vehicle body upper portion. As shown in this drawing, the roof headlining 14 includes a ceiling main body 16 formed in an overall generally rectangular flat sheet shape. This ceiling main body 16 is fixed to the vehicle body upper portion at a front end portion 16A, both of two side portions 16B, a center portion 16C, and a rear end portion 16D.

More specifically, a map lamp 18 is arranged in a vehicle width direction center portion of the front end portion 16A of the ceiling main body 16. Furthermore, sun visors 20 each formed in a rectangular flat sheet shape are arranged one on each side of the map lamp 18 in the vehicle width direction. Each of the sun visors 20 is attached to the vehicle body upper portion by a sun visor fixing seat 22 arranged on the vehicle width direction outside, and is held in a predetermined position by a sun visor holder 24 arranged on the vehicle width direction inside. The front end portion 16A of the ceiling main body 16 is fixed to the vehicle body upper portion (i.e., a front roof head panel, not shown) using the map lamp 18 and the sun visor fixing seats 22. Also, assist grips 26 are arranged in two locations front and rear on the two side portions 16B of the ceiling main body 16 in the vehicle width direction. These assist grips 26 are each formed in a general U-shape so as to be able to be gripped by an occupant, and are fixed to the vehicle body upper portion by assist grip mounting seats 28 set in two locations front and rear. The two side portions 16B of the ceiling main body 16 in the vehicle width direction are fixed to the vehicle body upper portion (i.e., a roof side rail, not shown) using the assist grip mounting seats 28. A generally trapezoidal recessed portion 32 into which an upper end portion of a center pillar garnish 30 (see FIG. 5) fits is formed near the middle portion, in the length direction, of each of the two side portions 16B of the ceiling main body 16. Further, a room lamp 34 is arranged in the center portion of the ceiling main body 16. The center portion 16C of the ceiling main body 16 is fixed to the vehicle body upper portion (i.e., a roof center reinforcement, not shown) using the room lamp 34. Meanwhile, the rear end portion 16D of the ceiling main body 16 is attached to the vehicle body upper portion (i.e., a rear roof head panel) by a plurality of dedicated resin clips 36. In this way, with the roof headlining 14, only the rear end portion 16D of the ceiling main body 16 is fixed to the vehicle body upper portion by the dedicated clips 36. The other portions, i.e., the front end portion 16A, the two side portions 16B, and the center portion 16C, are fixed to the vehicle body upper portion together with parts that are attached to the ceiling main body 16. As a result, the roof headlining 14 lines the upper portion of the cabin 12 from the cabin inside.

As shown in FIGS. 5 to 7, the ceiling main body 16 described above includes one surface 16E that faces the cabin inside, and another surface 16F that faces the cabin outside. The one surface 16E is a ceiling surface 38 that forms a design surface. Also, the other surface 16F is the back surface of the ceiling that faces a roof panel 40.

Here, grooves 42 that serve as a pair of left and right design portions are set in a V-shape when looking up from inside the cabin in the ceiling surface 38 described above, as shown in FIGS. 1 to 3 and FIG. 5. These grooves 42 will be described in detail below. Hereinafter, portions that are provided in plurality, such as these grooves 42, may be referred to in the singular to simplify the description and facilitate understanding.

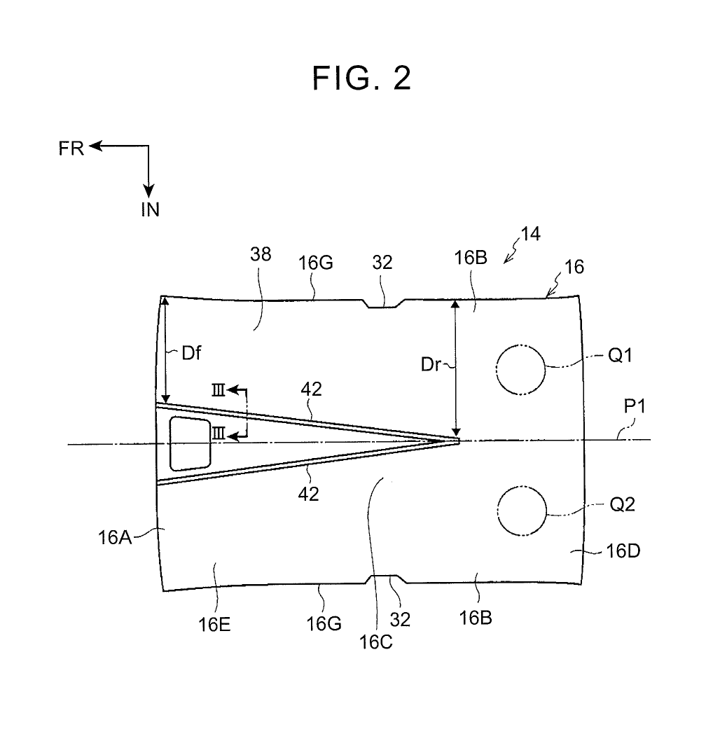

As shown in FIG. 2, each groove 42 is formed in a straight line running in the length direction of the ceiling main body 16 so as to be not parallel to a first center line P1 that extends in the length direction of the ceiling surface 38 and passes through a width direction middle position of the ceiling surface 38. Also, the pair of left and right grooves 42 is arranged bilaterally symmetrical with respect to the first center line P1.

More specifically, a front end of each groove 42 is positioned at the end of the front end portion 16A, and a rear end of each groove 42 is arranged on the first center line P1. Furthermore, when the roof headlining 14 is mounted to the automobile 10, the grooves 42 extend from the front end portion 16A of the ceiling main body 16 to beyond a front seat 44 (see FIG. 6), and moreover, beyond the recessed portion 32 described above, to obliquely forward of a position above the heads occupants seated in a rear seat 46 (i.e., rear occupants) (see FIG. 6). The heads of the rear occupants are indicated by chain double-dashed lines Q1 and Q2 in FIG. 2. Hereafter, the notation “head Q1” or “head position Q1” may be used in reference to the occupant on the right side of the rear seat 46, for example, depending on what is being described.

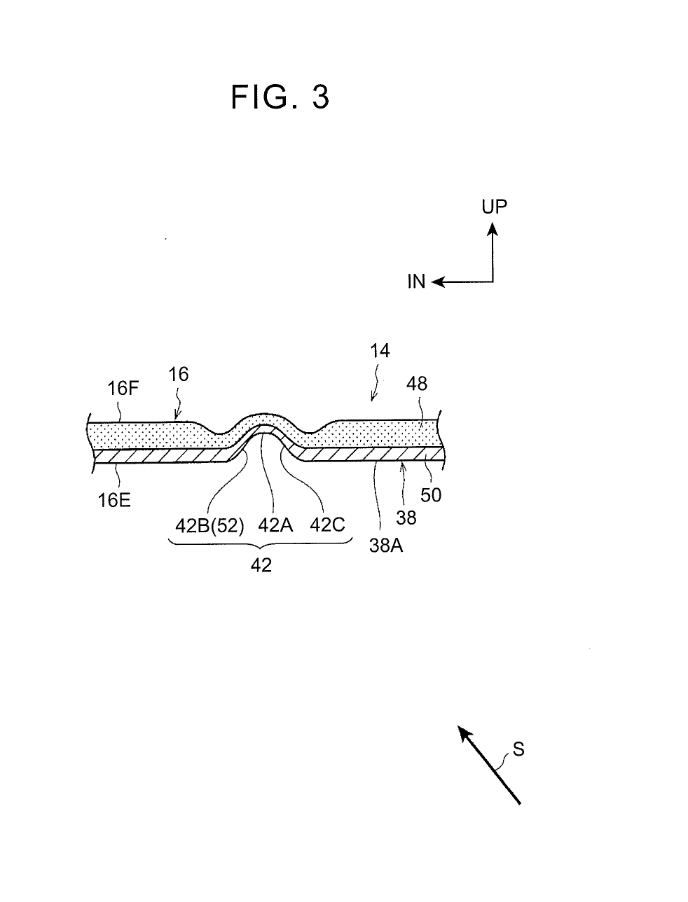

Each groove 42 as the linear design portion described above is formed by the shape of the ceiling main body 16 itself, as shown in FIG. 3. More specifically, the ceiling main body 16 of the roof headlining 14 is formed by a resin base material 48 that has a predetermined thickness, and a cover 50 that is provided on a lower surface of this base material 48. When forming this ceiling main body 16, the groove 42 is formed such that the cover 50 side is recessed (i.e., such that there is a protrusion toward the vehicle upward side when the roof headlining 14 is mounted to the automobile 10). The groove 42 formed in the ceiling main body 16 has a groove bottom portion 42A in a position farthest from a ceiling general surface 38A. A pair of groove inner peripheral inclined portions 42B and 42C is formed continuous on both the left and right sides of the groove bottom portion 42A. As a result, when a rear occupant seated on the right side of the rear seat 46 looks at the grooves 42 formed in the ceiling surface 38 in the direction of arrow S, only the groove inner peripheral inclined portion 42B on the side near the first center line P1 is visibly recognizable from the head position Q1 of the rear occupant. The area near the groove bottom portion 42A appears dark, and the visible groove inner peripheral inclined portion 42B looks like a bright highlight line. As a result, when viewed from the head position Q1 of the rear occupant, the groove 42 is on the whole recognized by the rear occupant as a single highlight line of a different color than the ceiling general surface 38A, and forms an accent line 52 that is accented with respect to the ceiling general surface 38A.

Also, as shown in FIGS. 1 and 2, each of the grooves 42 is formed in the ceiling surface 38 of the ceiling main body 16 such that a distance D between the groove 42 and an end 16G of a long side of the ceiling main body 16 is greater on the ceiling main body rear side (i.e., the vehicle rear side) than it is on the ceiling main body front side (vehicle front side). That is, the groove 42 is provided in the ceiling surface 38 such that the relationship of Df<Dr is satisfied. Here, Df refers to the distance between the groove 42 at the ceiling main body front side and the end 16G of the long side of the ceiling main body 16, and Dr refers to the distance between the groove 42 at the ceiling main body rear side and the end 16G of the long side of the ceiling main body 16. Furthermore, the groove 42 is provided in the ceiling surface 38 of the ceiling main body 16 such that the distance between the groove 42 and the end 16G of the long side of the ceiling main body 16 (directly proportionately) increases from the ceiling main body front side (i.e., the vehicle front side) toward the ceiling main body rear side (i.e., the vehicle rear side).

Also, the term “distance” here refers to the linear distance from the groove 42 to the end 16G of the long side of the ceiling main body 16, not to the rounded vehicle width direction length at both ends in the direction along the surface of the ceiling surface 38. This is because the rear occupants are more keenly aware of the vehicle width direction length of the space above the heads of the rear occupants than they are of the bulge of the ceiling surface 38. Here, when specifying the distance described above in the production and distribution processes of the roof headlining 14, all that need be obtained is the linear distance from the groove 42 to the end 16G of the long side of the ceiling main body 16, just as described above. When specifying the distance described above when the roof headlining 14 is in a state assembled to the automobile 10 (i.e., a state in which the roof headlining 14 is mounted to the automobile 10) as well, all that need be obtained is the linear distance from the groove 42 to the end 16G of the ceiling main body 16, just as described above.

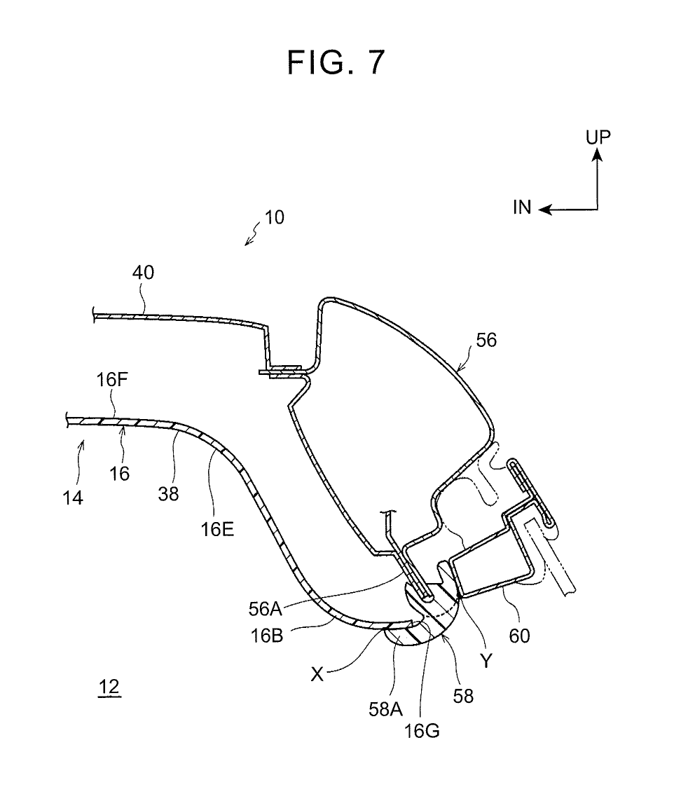

To elaborate further, when the roof headlining 14 is in a state mounted to the automobile 10, a fin portion 58A of an opening trim 58 that is fit together with a flange portion 56A of a roof side rail 56 elastically abuts against a terminal portion of the roof headlining 14 in the vehicle width direction, as shown in FIG. 7. Therefore, if the color of the surface of the opening trim 58 is a color such as black that is different from the interior color of the roof headlining 14, the rear occupant will recognize a parting line X between the fin portion 58A of the opening trim 58 and the ceiling surface 38 of the ceiling main body 16 as the “end of the long side of the ceiling main body”. Therefore, the parting line X may be substituted as the “end of the long side of the ceiling main body”. That is, the “distance” described above may be determined by measuring the distance from the groove 42 to this parting line X. Meanwhile, if the color of the surface of the opening trim 58 is a color such as beige that is the same type of color as the interior color of the roof headlining 14, the rear occupant will recognize a parting line Y created by the opening trim 58 contacting a door frame 60, as the “end of the long side of the ceiling main body”. Therefore, the parting line Y may be substituted as the “end of the long side of the ceiling main body”. That is, the “distance” described above may be determined by measuring the distance from the groove 42 to this parting line Y. The opening trim 58 is a long member with a uniform sectional shape, so the vehicle width direction dimension when the opening trim 58 is fitted to the flange portion 56A of the roof side rail 56 is constant. Therefore, either the parting line X or the parting line Y may be substituted as the “end of the long side of the ceiling main body” without any problem.

### Operation and Effects of this Example Embodiment

Next, the operation and effects of this example embodiment will be described.

In this example embodiment, the ceiling main body 16 is formed in a generally rectangular flat sheet shape, and one surface 16E thereof is the ceiling surface 38. Here, in this example embodiment, the groove 42 as the linear design portion is provided in the ceiling surface 38. This groove 42 extends in a straight line in the length direction of the ceiling main body 16, and is not parallel to the first center line P1 that extends in the length direction and passes through a width direction middle position of the ceiling surface 38. Therefore, when an occupant is seated in the rear seat 46 and faces forward while the roof headlining 14 is mounted to the automobile 10, the accent line 52 formed by the grooves 42 enters the field of view of the rear occupant, and a visual effect (a sense of perspective depth and a feeling of spaciousness in the vehicle width direction of the seating space) caused by the difference in distance (i.e., wide and narrow) between the accent line 52 and the end 16G of the long side the ceiling main body 16 is obtained. As a result, it is possible to make the rear occupant feel that the inside of the cabin 12 is spacious.

Also, in this example embodiment, the grooves 42 extend from the front end portion 16A of the ceiling main body 16 to beyond the front seat 44 while the roof headlining 14 is in a state mounted to the automobile 10, so the accent line 52 formed by the grooves 42 are accentuated for the rear occupant. As a result, according to this example embodiment, the visual effect for the rear occupant is able to be increased.

Furthermore, in this example embodiment, the grooves 42 are arranged bilaterally symmetrical with respect to the first center line P1, so the visual effect described above is also able to be obtained regardless of whether the occupant is seated on the right side or the left side of the rear seat 46. Also, when occupants are seated on both the left and right sides of the rear seat 46, the visual effect described above is able to be obtained for each of the occupants. As a result, with this example embodiment, rear occupants are able to feel that the inside of the cabin 12 is spacious regardless of the seating position of the rear occupants, and whether the number of rear occupants is one or two.

Also, in this example embodiment, the grooves 42 are provided in the ceiling main body 16 so that the distance D between each of the grooves 42 and the end 16G of the long side of the ceiling main body 16 is wider on the ceiling main body rear side than it is on the ceiling main body front side. That is, the distance between each of the grooves 42 and the end 16G of the long side of the ceiling main body 16 becomes wider toward the rear occupant. Therefore, when the roof headlining 14 is mounted to the automobile 10, the rear occupant will feel as though the space above his or her head is wider than it actually is in the width direction of the ceiling main body 16. As a result, the rear occupant is able to be made to feel that the inside of the cabin 12 is spacious in the vehicle width direction.

Moreover, in this example embodiment, the grooves 42 are formed by the shape of the ceiling main body 16 itself, so compared to a structure in which the accent line 52 is formed by another part that is attached to the ceiling main body 16, not only is the number of parts able to be reduced, but an extremely natural accent line 52 is able to be created. As a result, with this example embodiment, it is possible to give a rear occupant the feeling that the inside of the cabin 12 is naturally spacious.

In addition, the grooves 42 are formed by the shape of the ceiling main body 16 itself, so the rigidity of the ceiling main body 16 itself is able to be increased. As a result, the roof headlining 14 becomes easier to handle when it is assembled to the automobile 10, so assembling workability is able to be improved. Meanwhile, if rigidity equivalent to that of a current ceiling main body 16 is sufficient, the increase in rigidity obtained by the formation of the grooves 42 is able to be used to reduce the density (weight) and thickness of the ceiling main body 16. In this case, cost and mass are able to be reduced.

Also, this example embodiment is also advantageous in that it provides the rear occupant with the feeling that the cabin 12 is spacious all the time, without being effected by the environment (particularly brightness) that changes while driving.

### Modified Examples of the First Example Embodiment

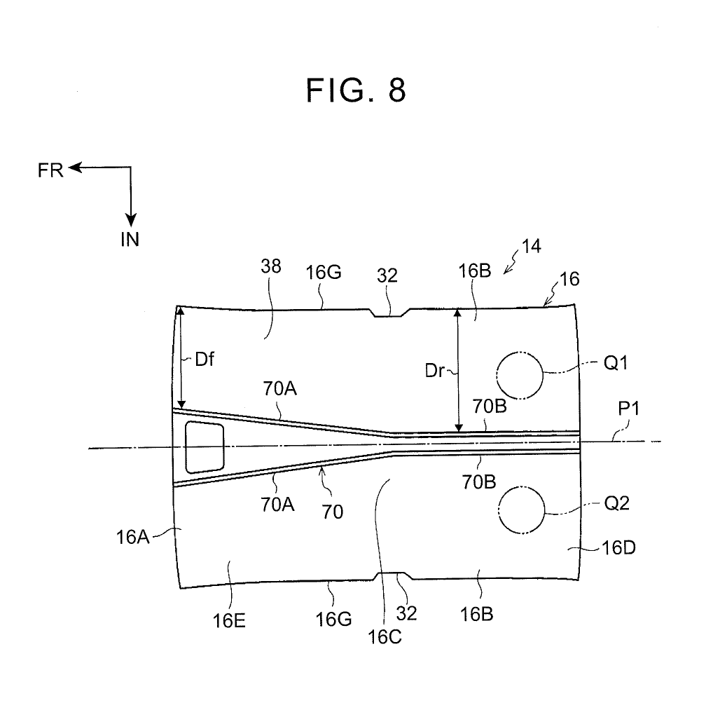

Hereinafter, modified examples of the first example embodiment described above will be described with respect to FIGS. 8 to 13. Component parts that are the same as those in the first example embodiment described above will be denoted by like reference characters, and descriptions of these parts will be omitted.

### First Modified Example

With the roof headlining 14 shown in FIG. 8, grooves 70 as linear design portions that resemble the pair of left and right grooves 42 formed in a V-shape shown in FIG. 2 described above are integrally formed in the ceiling surface 38. More specifically, these grooves 70 are formed from the front end portion 16A of the ceiling main body 16 to the rear end portion 16D without intersecting with the first center line P1. That is, the grooves 70 are formed by the grooves 42 shown in FIG. 2 that approach the first center line P1 and then curve at a position a predetermined distance away from the first center line P1, and extend parallel to the first center line P1 until the rear end portion 16D of the ceiling main body 16. In other words, each of the grooves 70 is formed by a linear inclined portion 70A that extends at an angle with respect to the first center line P1, and a linear parallel portion 70B that curves from a rear end of this inclined portion 70A and extends parallel to the first center line P1 until the rear end portion 16D of the ceiling main body 16. This parallel portion 70B does not have to extend to the rear end portion 16D of the ceiling main body 16, but may instead end before the rear end portion 16D. Also, when describing the corresponding relationship between the grooves 70 and the invention according to claim 1, the “inclined portion 70A” corresponds to the “portion positioned on the ceiling front side” in the invention according to claim 1, and this inclined portion 70A is the portion that is “not parallel”.

Moreover, the grooves 70 are formed bilaterally symmetrical with respect to the first center line P1, similar to the grooves 42 described above. Also, the grooves 70 are provided in the ceiling surface 38 of the ceiling main body 16 such that the distance D between each of the grooves 70 and the end 16G of the ceiling main body 16 is wider on the ceiling main body rear side (i.e., the vehicle rear side) than it is on the ceiling main body front side (i.e., the vehicle front side). That is, the grooves 70 are provided in the ceiling surface 38 in a manner such that the relationship of Df<Dr is satisfied.

According to the structure described above, the grooves 70 are structures that generally include the structure of the grooves 42 described above, so operation and effects similar to those of the example embodiment illustrated in FIG. 2 described above are able to be obtained.

### Second Modified Example

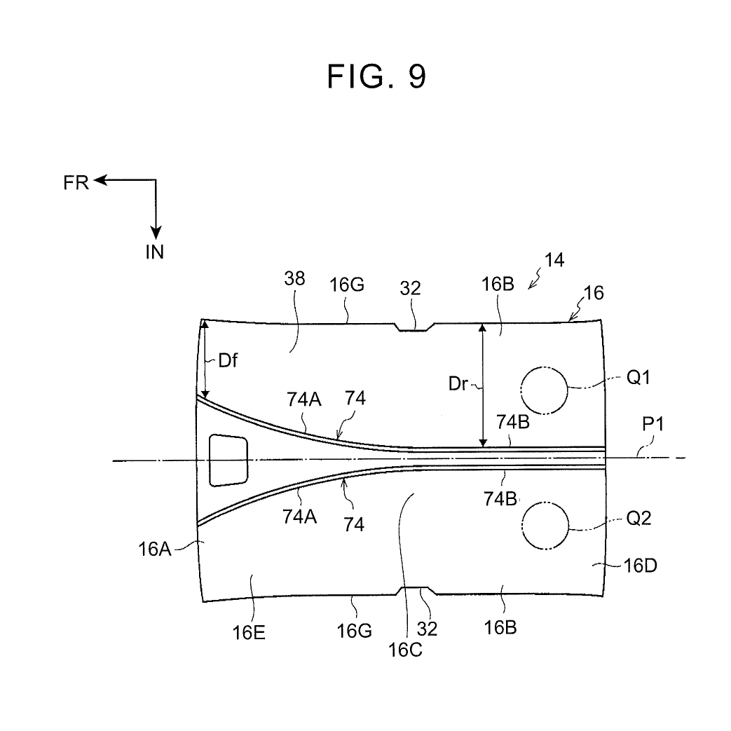

The roof headlining 14 shown in FIG. 9 is characteristic in that the inclined portions 70A of the grooves 70 shown in FIG. 8 described above are each formed in a curved shape. Accordingly, in this example embodiment, grooves 74 as the linear design portions are each formed by an inclined portion 74A that is arranged on the front side of the ceiling main body 16 and is formed in a gently arced shape, and a parallel portion 74B that is arranged on the rear side of the ceiling main body 16 and extends parallel to the first center line P1 from the rear end of the inclined portion 74A.

With this structure as well, the grooves 74 are structures that generally include the structure of the grooves 42 described above, so operation and effects similar to those of the example embodiment illustrated in FIGS. 2 and 8 described above are able to be obtained. Also, the inclined portions 70A are each formed in a curved shape, so compared to a first modified example shown in FIG. 8, the distance Df from the each of the grooves 74 on the ceiling main body front side to the end 16G of the long side of the ceiling main body 16 is shorter than the distance Df in the first modified example shown in FIG. 8. Therefore, a visual effect in which the narrow space on the ceiling main body front side suddenly becomes wider in front of the rear occupant is able to be obtained.

### Third Modified Example

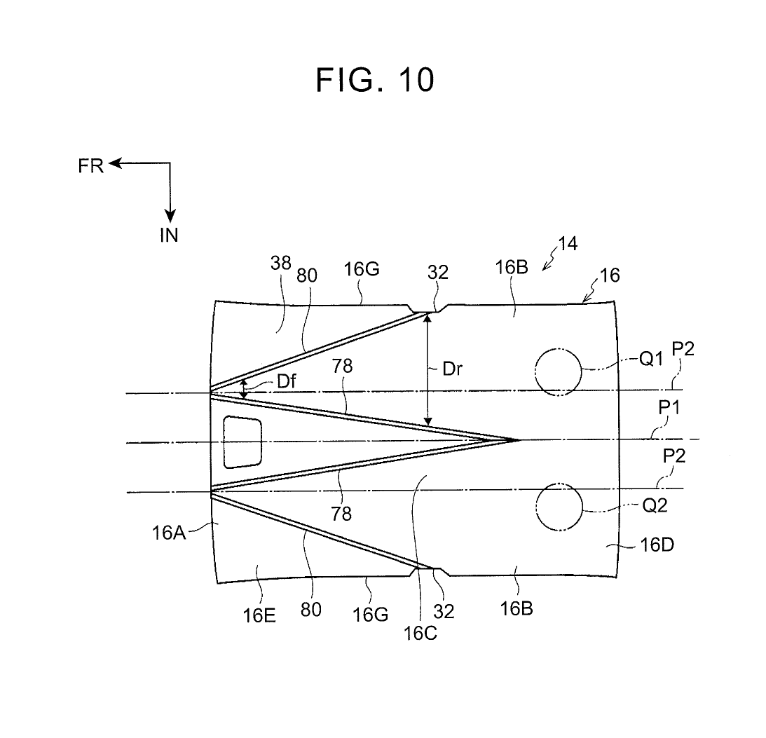

With the roof headlining 14 shown in FIG. 10, a plurality of linear design portions, i.e., inside inclined portions 78 and outside inclined portions 80, that are apart from each other in the width direction of the ceiling main body 16 between the first center line P1 and the end 16G of the ceiling main body 16, are integrally provided on the ceiling surface 38. Also, the inside inclined portions 78 and the outside inclined portions 80 extend separately on both the left and right sides of second center lines P2 that extend in the length direction of the ceiling surface 38 parallel to the first center line P1. The inside inclined portions 78 and the outside inclined portions 80 are each formed in straight lines and together form an overall general M-shape. When the inside inclined portions 78 and the outside inclined portions 80 of this structure are viewed from a different perspective, one could say that the grooves 42 shown in FIG. 2 are used as they are as the pair of left and right inside inclined portions 78, with the pair of left and right outside inclined portions 80 that reach the recessed portions 32 added to the vehicle width direction outside of these grooves 42.

Further, the inside inclined portion 78 and the outside inclined portion 80 are provided on the ceiling main body 16 in a manner such that the distance D between the inside inclined portion 78 and the outside inclined portion 80 is wider on the ceiling main body rear side than it is on the ceiling main body front side. That is, the inside inclined portion 78 and the outside inclined portion 80 are provided on the ceiling surface 38 such that the relationship of Df<Dr is satisfied. Furthermore, the inside inclined portion 78 and the outside inclined portion 80 are provided on the ceiling surface 38 of the ceiling main body 16 in a manner such that the distance D between the inside inclined portion 78 and the outside inclined portion 80 (directly proportionately) increases from the ceiling main body front side (i.e., the vehicle front side) toward the ceiling main body rear side (i.e., the vehicle rear side).

According to this structure, a plurality of the inside inclined portions 78 and the outside inclined portions 80 are provided apart from each other in the width direction of the ceiling main body 16 between the first center line P1 and the end 16G of the ceiling main body 16, and are provided on the ceiling main body in a manner such that the distance D between the inside inclined portion 78 and the outside inclined portion 80 is wider on the ceiling main body rear side than it is on the ceiling main body front side (i.e., Df<Dr). Therefore, when the roof headlining 14 is mounted to the automobile 10, the rear occupant feels as though the space above his or her head is even wider than it actually is in the width direction of the ceiling main body 16. As a result, according to this example embodiment, the rear occupant is able to feel that the inside of the cabin 12 is even more spacious in the vehicle width direction.

Also, in this example embodiment, the inside inclined portion 78 and the outside inclined portion 80 extend separated on both the left and right sides of the second center lines P2 that extend in the length direction of the ceiling surface 38 parallel to the first center line P1, so the accent line 52 of the inside inclined portion 78 and the outside inclined portion 80 is able to be effectively recognized by both eyes of the rear occupant. Therefore, the rear occupant is able to be provided with a strong visual effect. Accordingly, the rear occupant is able to effectively feel that the inside of the cabin 12 is spacious.

### Fourth Modified Example

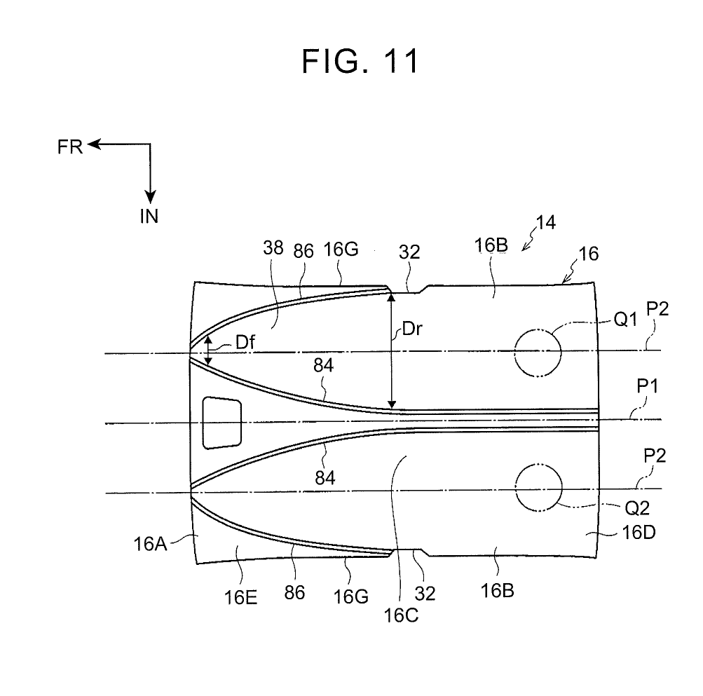

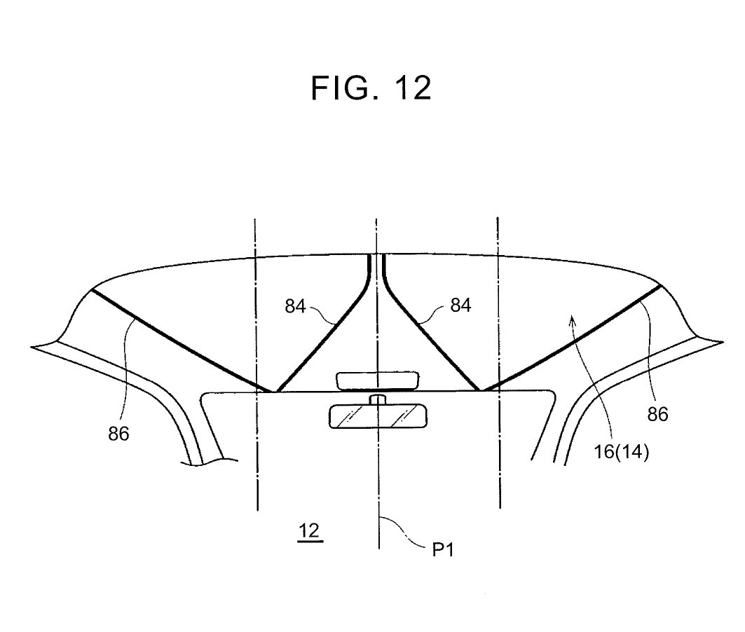

With the roof headlining 14 shown in FIGS. 11 and 12, a plurality of linear design portions, i.e., an inside inclined portion 84 and an outside inclined portion 86, that are apart from each other in the width direction of the ceiling main body 16 between the first center line P1 and the end 16G of the long side of the ceiling main body 16, are integrally provided on the ceiling surface 38. Also, the inside inclined portion 84 and the outside inclined portion 86 extend separated on both the left and right sides of the second center lines P2 that extend in the length direction of the ceiling surface 38 and pass through the centers of the heads Q1 and Q2 of the rear occupants, and together form an overall general M-shape overall. When the inside inclined portions 84 and the outside inclined portions 86 of this structure are viewed from a different perspective, one could say that the grooves 74 shown in FIG. 9 are used as they are as the pair of left and right inside inclined portions 84, with the pair of curved left and right outside inclined portions 86 that reach the recessed portions 32 and are curved toward the with direction outside of the ceiling surface 38 added to the vehicle width direction outside of these grooves 74.

Also, the inside inclined portion 84 and the outside inclined portion 86 are provided on the ceiling surface 38 of the ceiling main body 16 in a manner such that the distance between the inside inclined portion 84 and the outside inclined portion 86 is wider on the ceiling main body rear side than it is on the ceiling main body front side.

This structure has a structure similar to that of the third modified example shown in FIG. 10 described above, so operation and effects similar to those obtained by the third modified example are able to be obtained with this structure as well. Furthermore, with this structure, the inside inclined portion 84 and the outside inclined portion 86 extend separated on both the left and right sides of the second center lines P2 that extend in the length direction of the ceiling surface 38 and pass through the centers of the heads Q1 and Q2 of the rear occupants, so the accent line 52 of the inside inclined portion 84 and the outside inclined portion 86 is able to be most effectively recognized by both eyes of the rear occupant. Therefore, the rear occupant is able to be provided with the strongest visual effect. Accordingly, the rear occupant is able to effectively feel that the inside of the cabin 12 is spacious.

### Fifth Modified Example

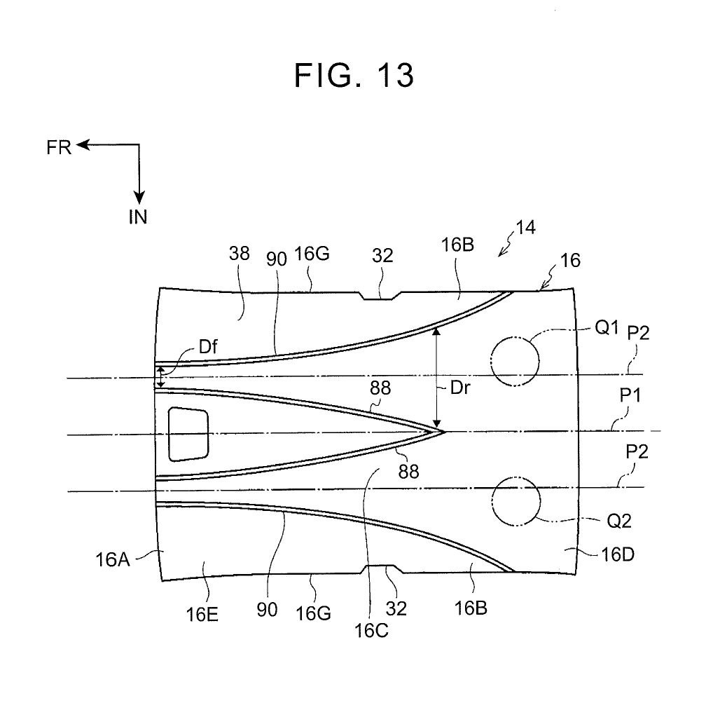

With the roof headlining 14 shown in FIG. 13, a plurality of linear design portions, i.e., an inside inclined portion 88 and an outside inclined portion 90, that are apart from each other in the width direction of the ceiling main body 16 between the first center line P1 and the end 16G of the long side of the ceiling main body 16, are integrally provided on the ceiling surface 38. Also, the inside inclined portion 88 and the outside inclined portion 90 extend separated on both the left and right sides of the second center lines P2 that extend in the length direction of the ceiling surface 38 parallel to the first center line P1. The inside inclined portion 88 and the outside inclined portion 90 are formed in a curved shape, and together form an overall general M-shape. The inside inclined portion 88 is formed in a curved shape that curves toward the width direction outside of the ceiling surface 38 with respect to the first center line P1. Also, the outside inclined portion 90 is formed in a curved shape that curves toward the inside inclined portion 88 side. Furthermore, a rear end portion of the outside inclined portion 90 extends to near the head position Q1 of the rear occupant.

This structure has a structure similar to that of the third modified example shown in FIG. 10 described above, so operation and effects similar to those obtained by the third modified example are also able to be obtained with this structure as well.

### Second Example Embodiment

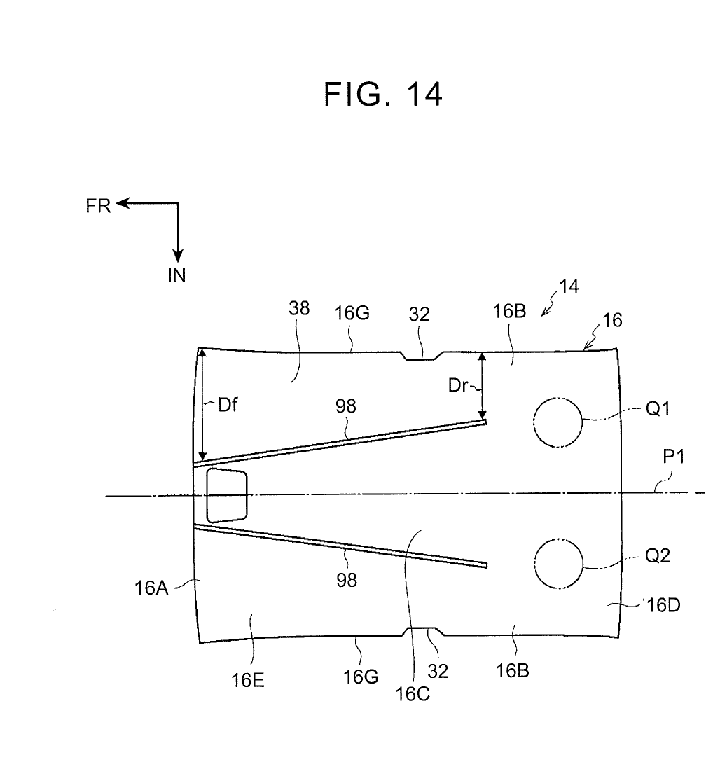

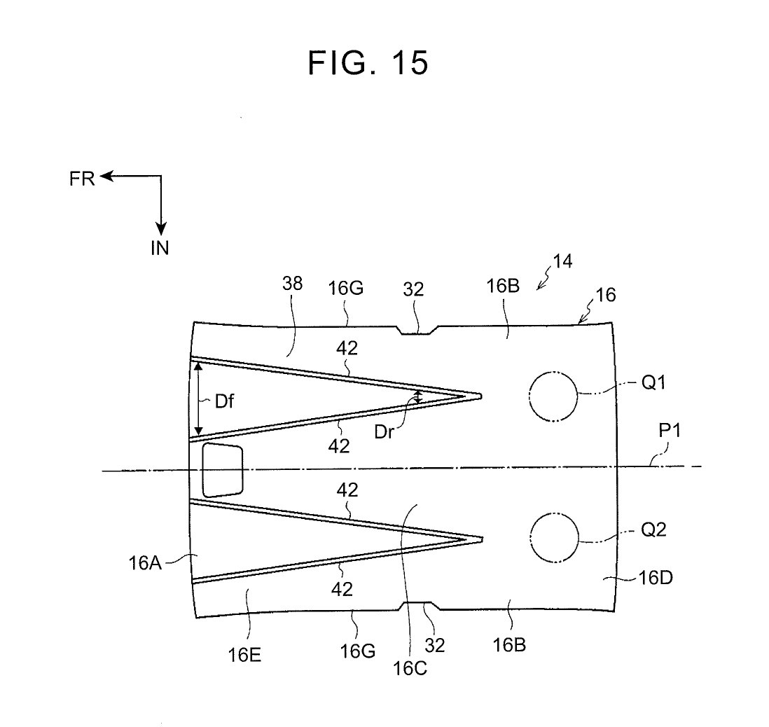

Next, a second example embodiment of the vehicle ceiling and the vehicle provided with this vehicle ceiling according to the invention will be described with reference to FIGS. 14 and 15. Component parts that are the same as those in the example embodiment described above will be denoted by like reference characters, and descriptions of these parts will be omitted.

### (Structure 1)

A first example of the second example embodiment shown in FIG. 14 is characterized in that grooves 98 are formed in the ceiling surface 38 of the ceiling main body 16 in a manner such that the distance D between each of the grooves 98 and the end 16G of the long side of the ceiling main body 16 is narrower (i.e., less) on the ceiling main body rear side (i.e., the vehicle rear side) than it is on the ceiling main body front side (i.e., the vehicle front side). That is, the grooves 98 are provided in the ceiling surface 38 such that the relationship of Df>Dr is satisfied. Moreover, the grooves 98 are provided in the ceiling surface 38 of the ceiling main body 16 such that the distance between each of the grooves 98 and the end 16G of the long side of the ceiling main body 16 directly proportionately) decreases from the ceiling main body front side (i.e., the vehicle front side) toward the ceiling main body rear side (i.e., the vehicle rear side).

The structure of the grooves 98 other than the characteristic of the groove 98 will now be briefly described. These grooves 98 are formed in a straight line similar to the grooves 42 of the first example embodiment shown in FIG. 2. A front end of each groove 98 extends in a straight line from the front end portion 16A toward the rear end portion 16D side of the ceiling main body 16, and terminates in a region beyond the recessed portion 32. Also, the grooves 98 are formed by the shape of the ceiling main body 16 itself. Furthermore, the left and right grooves 98 are formed bilaterally symmetrical with respect to the first center line P1.

### Operation and Effects

According to the structure described above, the grooves 98 are provided on the ceiling surface 38 in a manner such that the distance D between each groove 98 and the end 16G of the long side of the ceiling main body 16 is narrower on the ceiling main body rear side than it is on the ceiling main body front side. That is, the distance D between the groove 98 and the end 16G of the long side of the ceiling main body 16 becomes smaller toward the rear occupant. Therefore, when the roof headlining 14 is mounted to the automobile 10, the vehicle front side appears farther away than it actually is to the rear occupant. As a result, according to this example embodiment, it is possible to make the rear occupant feel that the inside of the cabin 12 is spacious in the vehicle front-rear direction.

Also, the same operation and effects as obtained in the first example embodiment are able to be obtained for portions having the same structure as in the first example embodiment described above.

### (Structure 2)

On the other hand, the next example of the second example embodiment shown in FIG. 15 is characterized in that the pair of grooves 42 described in the first example embodiment (i.e., the pair of grooves formed in a V-shape) are integrally formed, between the first center line P1 and the end 16G of the long side of the ceiling main body 16, in the ceiling surface 38 of the roof headlining 14. When described from another perspective, a plurality of the grooves 42 are provided apart from each other in the width direction of the ceiling main body 16 between the first center line P1 and the end 16G of the long side of the ceiling main body 16, and are provided on the ceiling main body 16 in a manner such that the distance D between the plurality of grooves 42 is wider on the ceiling main body rear side than it is on the ceiling main body front side. That is, the grooves 42 are provided in the ceiling surface 38 in a manner such that the relationship of Df>Dr is satisfied. The grooves 42 terminate in a region beyond the recessed portions 32.

### Operation and Effects

According to this structure, a plurality of the grooves 42 are provided apart from each other in the width direction of the ceiling main body 16 between the first center line P1 and the end 16G of the long side of the ceiling main body 16, and are provided on the ceiling surface 38 of the ceiling main body 16 in a manner such that the distance D between the plurality of grooves 42 is smaller on the ceiling main body rear side than it is on the ceiling main body front side. Therefore, when the roof headlining 14 is mounted to the automobile 10, vehicle front side appears even farther away than it actually is to the rear occupant. As a result, it is possible to make the rear occupant feel that the inside of the cabin 12 is spacious.

Also, operation and effects similar to those of the first example embodiment are able to be obtained for portions that have a structure similar to that in the first example embodiment described above.

### Modified Examples of the Structure of the Linear Design Portion

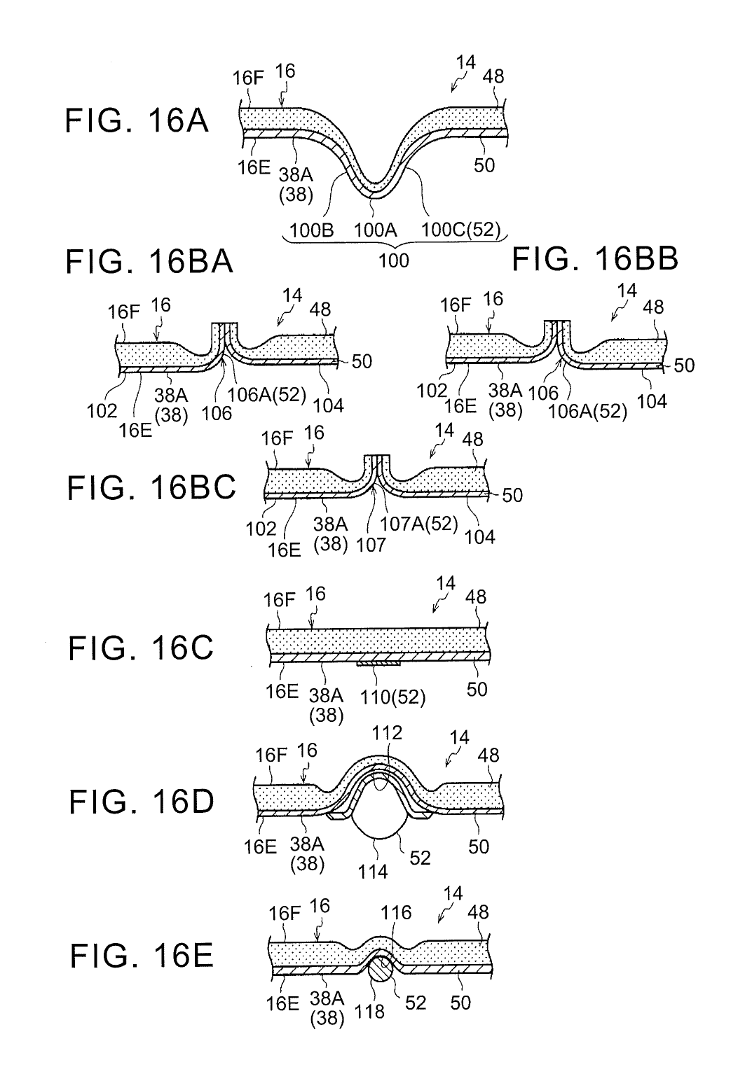

Next, several modified examples of the structure of the linear design portion (i.e., the grooves 42) described in the first example embodiment will be described with reference to FIG. 16. Component parts that are the same as those in the first example embodiment described above will be denoted by like reference characters, and descriptions of these parts will be omitted.

In a first modified example shown in FIG. 16A, a protruding portion 100 as the linear design portion is formed such that the cover 50 side forms a protrusion (so as to protrude on the vehicle lower side when the roof headlining 14 is in a state mounted to the automobile 10), instead of the groove 42. This protruding portion 100 is also formed by the shape of the ceiling main body 16 itself, similar to the groove 42. More specifically, when forming the ceiling main body 16, the protruding portion 100 is formed such that the cover 50 side protrudes. The protruding portion formed on the ceiling main body 16 has a tip end portion 100A in a position farthest from the ceiling general surface 38A, and a pair of outer peripheral inclined portions 100B and 100C are formed continuous on both the left and right sides of this tip end portion 100A. As a result, when the rear occupant views the protruding portion 100 (from the direction of arrow S in FIG. 3) that is formed on the ceiling surface 38, just as when described with reference to FIG. 3, only the outer peripheral inclined portion 100C on the side away from the first center line P1 is able to be visually recognized from the head position Q1 of the rear occupant, and the outer peripheral inclined portion 100C that is visually recognized appears as a bright highlight line. As a result, when viewed from the head position Q1 of the rear occupant, the protruding portion 100 is recognized by the rear occupant as a single highlight line of a different color than the ceiling general surface 38A overall, and forms the accent line 52 that is accented with respect to the ceiling general surface 38A.

In a second modified example shown in FIG. 16BA, the ceiling main body 16 is divided in the width direction, and a center side portion 102 positioned on the width direction center side protrudes farther toward the cabin 12 side, when mounted to the automobile 10, than an outside portion 104 that is positioned on the width direction outside. As a result, a step 106 is formed between the center side portion 102 and the outside portion 104, and a vertical surface 106A that forms this step 106 is visually recognizable to the rear occupant as the accent line 52. As shown in FIG. 16BB, conversely, the outside portion 104 may be configured to protrude farther toward the cabin 12 side, when mounted to the automobile 10, than the center side portion 102. In this case, the step 106 is formed between the outside portion 104 and the center side portion 102, but even in this case, when viewed from an occupant on the rear right side, the area near the lower end portion of the step 106 is recognized as a parting line with the center side portion 102, i.e., the accent line 52. Also, as shown in FIG. 16BC, the center side portion 102 and the outside portion 104 may also be arranged without a step. In this case, a step such as the step 106 described above, is not formed, but the accent line 52 is recognized on a vertical wall 107A formed on a mating portion 107, that serves as a linear design portion, of the center side portion 102 and the outside portion 104. Moreover, the colors of the divided center side portion 102 and the outside portion 104 may be changed.

In a third modified example shown in FIG. 16C, the accent line 52 is formed by adhering tape 110 of a different color than the ceiling surface 38 of the ceiling main body 16 to the surface of the ceiling surface 38. That is, in the third modified example, a highlight line is not formed. Instead, the tape 110 having a certain width is visually recognized by the rear occupant. Aside from adhering the tape 110 to the ceiling surface 38, painting a straight line on the ceiling surface 38, or a cover having a line that is visibly recognizable by the rear occupant may be used. Furthermore, an accent line may be formed by weaving linear material into the cover.

In a fourth modified example shown in FIG. 16D, a recessed portion 112 is formed on the ceiling surface 38 of the ceiling main body 16, and a rod-shaped lighting device 114 (a linear design portion) that is functional and is of different material than the ceiling main body 16 is attached to this recessed portion 112. During the day, the lighting device 114 is recognized by the rear occupant as a while line (an accent line) that has a width, and at night, light illuminated by the lighting device 114 is recognized as a white line that has a width. This example is also basically not an example embodiment in which a highlight line is formed. There is unevenness at the boundary and the like between the lighting device 114 and the ceiling surface 38, so some shade is created by this unevenness, but more than this, the lighting device 114 itself need simply be understood to be an example that forms an accent line.

In a fifth modified example shown in FIG. 16E, a recessed portion 116 is formed on the ceiling surface 38, and a decorative part 118 as a linear design portion formed by a wiry resin member with a metallic surface, for example, may be attached to the recessed portion 116. This example is also basically not an example embodiment in which a highlight line is formed. There is unevenness at the boundary and the like between the decorative part 118 and the ceiling surface 38, so some shade is created by this unevenness, but more than this, the decorative part 118 itself need simply be understood to be an example that forms an accent line.

In the first and second modified examples shown in FIGS. 16A, 16BA, 16BB, and 16BC, the linear design portion is formed by the shape of the ceiling main body 16 itself, so an extremely natural accent line 52 is able to be created, similar to the grooves 42 in the first example embodiment. As a result, it is possible to make the rear occupant feel that the inside of the cabin 12 is naturally spacious. On the other hand, in the third, fourth, and fifth modified examples shown in FIGS. 16C, 16D, and 16E, the linear design portion is formed by a separate part that is different from the ceiling main body 16, so the degree of freedom in design is increased, which is advantageous. Furthermore, when a part that functions as independent lighting, as in the fourth modified example shown in FIG. 16D, both a lighting effect inside the cabin 12 and a visual effect for the rear occupant are added to the roof headlining 14, so a feeling of luxury is able to be produced. Moreover, by adding a lighting device that is parallel to the roof side rail 56 to the width direction outside of the ceiling main body 16, a visual effect for the rear occupant that is the same as at night is able to be obtained, and the inside of the cabin 12 is also able to be made substantially evenly bright, by the added lighting device on the outside and the lighting device 114 on the center side. Also, if the lighting device 114 is illuminated in order from the vehicle front side toward the vehicle rear side, the rear occupant can be made to feel a sense of speed.

### Supplementary Description of the Example Embodiments

In the example embodiments described above, the linear design portion is formed on both the left and right sides of the first center line P1, but the linear design portion may alternatively be provided on only one side. In this case, the visual effects described above are able to be obtained on only the side where the linear design portion is provided.

Also, in the example embodiments described above, the linear design portion is a linear design portion that is in a straight line, but the linear design portion is not limited to this. That is, the linear design portion may also be in a curved line.

What is claimed is:

1. A vehicle ceiling comprising:
a ceiling main body that is formed in a generally rectangular flat sheet shape, one surface of the ceiling main body being a ceiling surface; and
a linear design portion that extends in a straight line or a curved line in a length direction of the ceiling main body such that at least a portion that is positioned on a ceiling front side is not parallel to a first center line, and that forms an accent that is visibly recognizable by a rear occupant when the vehicle ceiling is mounted to a vehicle, wherein
the first center line extends in the length direction and passes through a width direction middle position of the ceiling surface.

2. The vehicle ceiling according to claim 1, wherein
the linear design portion extends beyond a front seat from a front end portion of the ceiling main body, when the vehicle ceiling is mounted to the vehicle.

3. The vehicle ceiling according to claim 1, wherein
a plurality of the linear design portion are arranged bilaterally symmetrical with respect to the first center line.

4. The vehicle ceiling according to claim 1, wherein
the linear design portion is provided on the ceiling main body in a manner such that a distance between the linear design portion and a long side edge of the ceiling main body is wider on a ceiling main body rear side than on a ceiling main body front side.

5. The vehicle ceiling according to claim 1, wherein
the linear design portion is provided on the ceiling main body in a manner such that a distance between the linear design portion and a long side edge of the ceiling main body is narrower on a ceiling main body rear side than on a ceiling main body front side.

6. The vehicle ceiling according to claim 1, wherein
a plurality of the linear design portions are provided apart from each other in a width direction of the ceiling main body between the first center line and a long side edge of the ceiling main body, and
the plurality of the linear design portions are provided on the ceiling main body in a manner such that a distance between the plurality of linear design portions is wider on a ceiling main body rear side than on a ceiling main body front side.

7. The vehicle ceiling according to claim 1, wherein
a plurality of the linear design portions are provided apart from each other in a width direction of the ceiling main body between the first center line and a long side edge of the ceiling main body, and
the plurality of the linear design portions are provided on the ceiling main body in a manner such that a distance between the plurality of linear design portions is narrower on a ceiling main body rear side than on a ceiling main body front side.

8. The vehicle ceiling according to claim 6, wherein
the plurality of linear design portions extend separated on both left and right sides of a second center line that extends in a length direction of the ceiling surface, parallel to the first center line.

9. The vehicle ceiling according to claim 8, wherein
the second center line passes through a center of an occupant seating position in a rear seat.

10. The vehicle ceiling according to claim 1, wherein
the linear design portion is formed by a shape of the ceiling main body itself.

11. A vehicle comprising:
a cabin that forms a space where an occupant rides; and
the vehicle ceiling according to claim 1 that lines an upper portion of the cabin, such that the ceiling surface on which the linear design portion is provided faces an inside of the cabin.
